(19) United States
(12) Patent Application Publication
(10) Pub. No.: US 2025/0333325 A1
(43) Pub. Date: Oct. 30, 2025

(54) OXYHALIDE ELECTROLYTES AND EFFICIENT METHODS FOR MAKING THE SAME

(71) Applicant: Florida State University Research Foundation, Inc., Tallahassee, FL (US)

(72) Inventors: Yan-Yan Hu, Tallahassee, FL (US); Bright Ogbolu, Tallahassee, FL (US); Thilina Nadeemali Dikella Dikella Gamaralalage, Tallahassee, FL (US)

(21) Appl. No.: 19/193,225

(22) Filed: Apr. 29, 2025

Related U.S. Application Data
(60) Provisional application No. 63/640,445, filed on Apr. 30, 2024.

(51) Int. Cl. C01G 35/00; G01N 27/333; H01M 10/0562; H01M 50/434

(52) U.S. Cl. CPC C01G 35/006; G01N 27/333; H01M 10/0562; H01M 50/434; C01P 2002/72; C01P 2002/85; C01P 2002/86; C01P 2004/03; C01P 2006/40; H01M 2300/0071; H01M 2300/008

(57) ABSTRACT

In accordance with the purpose(s) of the present disclosure, as embodied and broadly described herein, the disclosure, in one aspect, relates to oxyhalide electrolytes and synthesis of oxyhalide electrolytes. The electrolytes have the general formula A_{z}N_{v-y}M_{y}OX_{5-y}, exhibit superionic conductivity, and can be produced via a relatively fast synthesis route. The electrolytes can be a component of different types of batteries or sensors for ion detection.

### CROSS-REFERENCE TO RELATED APPLICATIONS

This application claims the benefit of and priority to co-pending U.S. Provisional Patent Application No. 63/640,445, filed on Apr. 30, 2024, the contents of which are incorporated by reference herein in their entireties.

### STATEMENT REGARDING FEDERALLY SPONSORED RESEARCH OR DEVELOPMENT

This invention was made with Government support under contract DMR-1847038 awarded by the National Science Foundation. The Government has certain rights in the invention.

### BACKGROUND

The burgeoning interest towards sustainable and renewable energy has engendered a need to develop fast-ion conducting solid electrolytes to cater for the ever-increasing demand for energy storage devices, such as smart battery systems and all-solid-state batteries. Solid electrolytes have many advantages over commercial liquid electrolytes, such as high Li-ion transference number, higher energy and power density, and improved safety. Ideally, a solid electrolyte should be feasible to produce, exhibit mechanical and chemical stability, and have good electrochemical properties. However, many solid electrolytes require extended synthesis time to produce, reducing their energy-efficiency and practicality to produce on a large scale. Therefore, there is a need for solid electrolytes that have good mechanical and electrochemical properties and are economically feasible to produce and scale-up.

### SUMMARY

In accordance with the purpose(s) of the present disclosure, as embodied and broadly described herein, the disclosure, in one aspect, relates to oxyhalide electrolytes and synthesis of oxyhalide electrolytes. The electrolytes have the general formula A_{z}N_{v-y}M_{y}OX_{5-y}, exhibit superionic conductivity, and can be produced via a relatively fast synthesis route. The electrolytes can be a component of different types of batteries or sensors for ion detection.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a representative Nyquist plot and corresponding equivalent circuit fitting at 25° C. for Li₂Ta_{0.9}Zr_{0.1}OCl_{4.9} (LTZOC).

FIG. 1B shows a representative Nyquist plot and corresponding equivalent circuit fitting at −20° C. for LTZOC.

FIG. 1C shows variable-temperature Nyquist plots obtained for LTZOC.

FIG. 1D shows an Arrhenius-type plot of LTZOC, activation energy is derived from the slope.

FIG. 2A shows results of DC-Polarization on a symmetric SS|LTZOC|SS cell (SS: stainless steel) for the determination of electronic conductivity (σₑₗ).

FIG. 2B shows I-V curves of LTZOC under different DC voltages with a linear fit. The electric resistances were calculated based on Ohm's law. The conductivity values were calculated by considering the sample's geometric dimensions.

FIG. 3 shows a linear sweep voltammetry curve for evaluating the electrochemical stability window of LTZOC.

FIG. 4 shows lab X-ray diffraction of glassy LTZOC and Li₂TaOCl₅.

FIG. 5 shows a deconvoluted ⁶Li NMR spectrum of LTZOC showing three Li local environments at −0.72 ppm, −0.60 ppm, and 2.87 ppm.

FIG. 6 shows the scanning electron microscope (SEM) and energy dispersive spectroscopy (EDS) mapping of as milled Li₂Ta_{0.8}Zr_{0.2}OCl_{4.8}.

FIGS. 7A-7B show the variable temperature ⁷Li NMR T₁ relaxation measurement for (a) Li₂Ta_{0.8}Zr_{0.2}OCl_{4.8} and (b) Li₂ZrOCl₄.

FIGS. 8A-8B show the all-solid-state battery cycling performance of Li₂Ta_{0.8}Zr_{0.2}OCl_{4.8} (a) rate capability plots and (b) voltage-capacity profiles showing the charge-discharge curves at 0.05, 0.1, 0.2, 0.5 and 1 C.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an excipient” include, but are not limited to, mixtures or combinations of two or more such excipients, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range. Thus, for example, if a component is in an amount of about 1%, 2%, 3%, 4%, or 5%, where any value can be a lower and upper endpoint of a range, then any range is contemplated between 1% and 5% (e.g., 1% to 3%, 2% to 4%, etc.).

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### Oxyhalide Electrolytes and Methods of Making and Using the Same

The present disclosure, in one aspect, provides for oxyhalide compounds and electrolytes and the method of making and using oxyhalide compounds and electrolytes. The electrolytes or compounds disclosed herein have the general formula A_{z}N_{v-y}M_{y}OX_{5-y} and exhibit superionic properties even at low temperatures. The electrolytes can be produced using inexpensive materials and a relatively rapid synthesis process, making them viable for production scale-up and commercialization. The electrolytes can also be characterized by a softness or deformability that can benefit conformal contact with electrode interfaces, improving the mechanical stability of devices comprising the electrolytes and enhancing ion transport efficiency. The electrolytes can be a component of different types of batteries, such as solid-state batteries.

In one aspect, the electrolytes or compounds disclosed herein have the formula A_{z}N_{v-y}M_{y}OX_{5-y}, where A is Li, Na, K, or any combination thereof; N is Ta, Nb, or a combination thereof; M is Zr, Hf, or a combination thereof; X is Cl, Br, I, or any combination thereof; z is greater than zero to about 3; y is greater than zero to about 5; v is greater than or equal to y; and the sum (z+5v) is equal to 7.

In one aspect, z can be from about 0.01 to about 3.0, or about 0.01, 0.1, 0.25, 0.5, 0.75, 1.0, 1.25, 1.5, 1.75, 2.0, 2.25, 2.5, 2.75, or 3.0, where any value can be a lower and upper endpoint of a range (e.g., 1.0 to 2.0).

In one aspect, v can be from about 0.01 to about 5.0, or about 0.01, 0.1, 0.25, 0.5, 0.75, 1.0, 1.25, 1.5, 175, 2.0, 2.25, 2.5, 275, 3.0, 3.25, 3.5, 3.75, 4.0, 4.25, 4.5, 4.75, or 5.0, where any value can be a lower and upper endpoint of a range (e.g., 0.1 to 2.0).

In another aspect, for any formula of electrolyte or compound disclosed herein, y can be from about 0.01 to about 5.0, or about 0.01, 0.1, 0.25, 0.5, 0.75, 1.0, 1.25, 1.5, 175, 2.0, 2.25, 2.5, 275, 3.0, 3.25, 3.5, 3.75, 4.0, 4.25, 4.5, 4.75, or 5.0, where any value can be a lower and upper endpoint of a range (e.g., 0.1 to 2.0). In a further aspect, the compound or electrolyte is Li₂Ta_{1-y}Zr_{y}OCl_{5-y}, where y is from about 0.01 to about 0.50, or about 0.01, 0.05, 0.1, 0.15, 0.2, 0.25, 0.3, 0.35, 0.4, 0.45, or 0.5, where any value can be a lower and upper endpoint of a range (e.g., 0.1 to 0.3). In another aspect, the compound or electrolyte is Li₂Ta_{0.9}Zr_{0.1}OCl_{4.9} or Li₂Ta_{0.8}Zr_{0.2}OCl_{4.8}.

The electrolytes disclosed herein have several desirable properties. In one aspect, the electrolytes can have good ionic conductivity. The electrolytes can have an ionic conductivity of at least about 1.00 mS/cm, at least about 2.00 mS/cm, at least about 3.00 mS/cm, at least about 3.50 mS/cm, at least about 4.00 mS/cm, at least about 4.50 mS/cm, or at least about 5.00 mS/cm. In another aspect, the ionic conductivity of the electrolytes can be from about 1.00 mS/cm to about 6.00 mS/cm, or about 1.00 mS/cm, 1.50 mS/cm, 2.00 mS/cm, 2.50 mS/cm, 3.00 mS/cm, 3.50 mS/cm, 4.00 mS/cm, 4.50 mS/cm, 5.00 mS/cm, 5.50 mS/cm, or 6.00 mS/cm, where any value can be a lower and upper endpoint of a range (e.g., 3.00 mS/cm to 6.00 mS/cm). The electrolytes can be characterized as having superionic conductivity, which refers to ionic conductivity values that are greater than 1 mS/cm. In one aspect, the electrolytes remain conductive over a temperature range of about −20° C. to about 80° C., or about −20° C., −10° C., 0° C., 10° C., 20° C., 30° C., 40° C., 50° C., 60° C., 70° C., or 80° C., where any value can be a lower and upper endpoint of a range (e.g., −20° C. to 80° C.). In another aspect, the electrolytes exhibit superionic conductivity over the same temperature ranges. Methods for determining ionic conductivity are provided in the Examples.

In one aspect, the electrolytes disclosed herein can have low electronic conductivities. The electrolytes can have an electronic conductivity of less than about 1.00×10⁻⁸ S/cm, less than about 5.00×10⁻⁹ S/cm, less than about 1.00×10⁻⁹ S/cm, less than about 5.00×10⁻¹⁰ S/cm, or less than about 1.00×10⁻¹⁰ S/cm. In another aspect, the electrolytes can have an electronic conductivity of from about 1.00×10⁻⁸ S/cm to about 1.00×10⁻¹¹ S/cm, or about 1.00×10⁻⁸ S/cm, 5.00×10⁻⁹ S/cm, 1.00×10⁻⁹ S/cm, 5.00×10⁻¹⁰ S/cm, 1.00×10⁻¹⁰ S/cm, 5.00×10⁻¹¹ S/cm, or 1.00×10⁻¹¹ S/cm, where any value can be a lower and upper endpoint of a range (e.g., 1.00×10⁻⁹ S/cm to 1.00×10⁻¹¹ S/cm). Methods for determining electronic conductivity are provided in the Examples.

In another aspect, the electrolytes disclosed herein can have relatively low activation energy barriers to ion transport. The electrolytes can have an activation energy of from about 0.1 eV to about 0.6 eV, or about 0.1 eV, 0.2 eV, 0.3 eV, 0.4 eV, 0.5 eV or 0.6 eV, where any value can be a lower and upper endpoint of a range (e.g., 0.3 eV to 0.4 eV).

The compounds or electrolytes can be cost-effective to produce due at least in part to the use of naturally abundant elements to synthesize them. One measurement of the element's abundance is the element's Earth crust abundance, or an estimate of the amount of the element present in the Earth's upper continental crust. In one aspect, at least one element or at least two elements present in the compound have an Earth crust abundance of at least 140 mg/kg (mg of element per kg crust). In a further aspect, one element or two elements present in the compound have an Earth crust abundance of at least 140 mg/kg. In another aspect, at least one element present in the compound has an Earth crust abundance of from 140 mg/kg to about 200 mg/kg. In another aspect, at least two elements present in the compound have an Earth crust abundance of from 140 mg/kg to about 200 mg/kg.

In one aspect, the electrolytes or compounds disclosed herein are disordered with a glassy or amorphous structure.

Additionally, the electrolytes described herein possess unique solid-state NMR spectra. In one aspect, the Li-containing electrolytes can have peaks at about −1.1 ppm and 2.87 ppm, with a broad peak extending from about −0.72 ppm to about −0.60 ppm, as determined by ⁶Li solid-state NMR spectroscopy. Exemplary methods for performing NMR measurements are provided in the Examples.

Also disclosed is a method for making sulfide electrolytes having the formula A_{z}N_{v-y}M_{y}OX_{5-y}, where A is Li, Na, K, or any combination thereof; N is Ta, Nb, or a combination thereof; M is Zr, Hf, or a combination thereof; X is Cl, Br, I, or any combination thereof; z is greater than zero to about 3; y is greater than zero to about 5; v is greater than or equal to y; and the sum (z+5v) is equal to 7. The method includes combining a plurality of precursor compounds, such as salt, in various amounts in the solid state and mixing them together by mechanochemical milling. In one aspect, the precursor compounds are mixed together in stoichiometric amounts. The precursor compounds mixed together can include A₂O, NX₅, MX₄, and any combination thereof, to produce a precursor mixture. In a further aspect, the precursor compounds mixed together can include A₂O, selected from the group of Li₂O, Na₂O, K₂O, and any combination thereof; NX₅, selected from the group of TaCl₅, TaBr₅, TaI₅, NbCl₅, NbBr₅, NbI₅, and any combination thereof; and MX₄, selected from the group of ZrCl₄, ZrBr₄, ZrI₄, HfCl₄, HfBr₄, HfI₄, and any combination thereof. The components of the precursor mixture can be hand-ground before mechanochemical milling to form a homogenous precursor mixture. In another aspect, forming the precursor mixture and/or forming the homogenous precursor mixture can be performed in an inert atmosphere, such as an argon or nitrogen atmosphere, with an O₂ content of less than 20 ppm, less than 10 ppm, less than 1 ppm, less than 0.5 ppm, or less than 0.1 ppm.

The compounds used to produce the electrolytes described herein are generally highly pure materials. In one aspect, each of the compounds has a purity of greater than 99%, greater than 99.5%, or greater than 99.9%. In one aspect, each compound used to produce the electrolytes are substantially anhydrous, where each compound is at least 95% moisture free, at least 98% moisture free, at least 99% moisture free, at least 99.9% moisture free, or 100% moisture free. In another aspect, each compound has less than 0.5 ppm water, less than 0.25 ppm water, or less than 0.1 ppm water.

The precursor compounds can be mixed by mechanochemical milling. Mixing of the precursor compounds can occur in a mixing jar or container using one or more balls to produce a complex motion that combines back-and-forth swings with short lateral movements. In one aspect, the precursor compounds are mixed with one another for less than 7 hours, less than 5 hours, or less than 3 hours. In another aspect, the compounds are mixed from about 1 hour to about 5 hours or about 1 hour, 2 hours, 3 hours, 4 hours, or 5 hours, where any value can be a lower and upper endpoint of a range (e.g., 1 hour to 4 hours). In one aspect, the precursor compounds are mixed in an inert atmosphere such as, for example, nitrogen or argon. In one aspect, the inert atmosphere has less than 20 ppm oxygen, less than 10 ppm oxygen, less than 1 ppm oxygen, less than 0.5 ppm oxygen, less than 0.25 ppm oxygen, or less than 0.1 ppm oxygen. In one aspect, the mixture is further dried after mixing. After mixing, the mixture can be pelletized. The pellets can be formed by pressing the mechanochemically milled mixture into a mold.

The compounds disclosed herein can be components of different types of batteries, such as solid-state batteries. The component of the battery including the compounds can be an electrolyte, a separator membrane, or a combination thereof. A separator membrane can be placed between the anode and the cathode of a battery. The separator membrane can be a porous membrane with an electrolyte dispersed within it, such as any one of the sulfide electrolytes disclosed herein. In one aspect, the separator membrane can function as both the separator between the electrodes and as the electrolyte. The compounds disclosed herein can also be components of different types of sensors, such as ion-selective electrodes, that are configured for ion detection (e.g., Li⁺ detection). Sensors can be used, for example, to measure or detect metal contamination in water sources or biofluids. An ion-selective electrode can comprise a substrate, an alkali-metal layer, such as a layer comprising any of the sulfide electrolytes or compounds disclosed herein, deposited onto the substrate, and an ion sensitive membrane, comprising a material such as poly(vinyl chloride).

### ASPECTS

Aspect 1. A compound having the formula A_{z}N_{v-y}M_{y}OX_{5-y}, wherein A is Li, Na, K, or any combination thereof; N is Ta, Nb, or a combination thereof; M is Zr, Hf, or a combination thereof; X is Cl, Br, I, or any combination thereof; z is greater than zero to about 3; y is greater than zero to about 5; v is greater than or equal to y; and the sum (z+5v) is equal to 7.

Aspect 2. The compound of aspect 1, wherein A is Li.

Aspect 3. The compound of aspect 1, wherein A is Na.

Aspect 4. The compound of any one of aspects 1-3, wherein z is from about 0.01 to about 3.0.

Aspect 5. The compound of any one of aspects 1-3, wherein z is from about 1.0 to about 2.0.

Aspect 6. The compound of any one of aspects 1-5, wherein Nis Ta.

Aspect 7. The compound of any one of aspects 1-6, wherein M is Zr.

Aspect 8. The compound of any one of aspects 1-7, wherein X is Cl.

Aspect 9. The compound of any one of aspects 1-7, wherein X is Br.

Aspect 10. The compound of any one of aspects 1-9, wherein y is from about 0.01 to about 5.00.

Aspect 11. The compound of any one of aspects 1-9, wherein y is from about 0.01 to about 3.00.

Aspect 12. The compound of any one of aspects 1-9, wherein y is from about 0.01 to about 0.50.

Aspect 13. The compound of any one of aspects 1-12, wherein v is from about 0.01 to about 5.00.

Aspect 14. The compound of any one of aspects 1-12, wherein v is from about 0.01 to about 3.00.

Aspect 15. The compound of aspect 1, wherein the compound is Li₂Ta_{1-y}Zr_{y}OCl_{5-y}.

Aspect 16. The compound of aspect 15, wherein y is from wherein y is from about 0.01 to about 5.

Aspect 17. The compound of aspect 15, wherein y is from wherein y is from about 0.01 to about 3.

Aspect 18. The compound of aspect 15, wherein y is from wherein y is from about 0.01 to about 0.50.

Aspect 19. The compound of aspect 1, wherein the compound is Li₂Ta_{0.9}Zr_{0.1}OCl_{4.9} or Li₂Ta_{0.8}Zr_{0.2}OCl_{4.8}.

Aspect 20. The compound of any one of aspects 1-19, wherein the compound has an ionic conductivity of at least about 1.0 mS/cm.

Aspect 21. The compound of any one of aspects 1-19, wherein the compound has an ionic conductivity of about 1.0 mS/cm to about 6.0 mS/cm.

Aspect 22. The compound of any one of aspects 1-21, wherein the compound has an electronic conductivity of less than 1.00×10⁻⁸ S/cm.

Aspect 23. The compound of any one of aspects 1-21, wherein the compound has an electronic conductivity of about 1.00×10⁻⁸ S/cm to about 1.00×10⁻¹¹ S/cm.

Aspect 24. The compound of any one of aspects 1-23, wherein the compound is conductive over a temperature range of about −20° C. to about 80° C.

Aspect 25. The compound of any one of aspects 1-24, wherein the compound exhibits superionic conductivity over a temperature range of about −20° C. to about 80° C.

Aspect 26. The compound of any one of aspects 1-25, wherein the compound has an activation energy for ion transport of from about 0.1 eV to about 0.6 eV.

Aspect 27. The compound of any one of aspects 1-25, wherein the compound has an activation energy for ion transport of from about 0.3 eV to about 0.4 eV.

Aspect 28. The compound of any one of aspects 1-27, wherein at least one element present in the compound has an Earth crust abundance of at least about 140 mg/kg.

Aspect 29. The compound of any one of aspects 1-27, wherein at least one element present in the compound has an Earth crust abundance of from about 140 mg/kg to about 200 mg/kg.

Aspect 30. The compound of any one of aspects 1-27, wherein at least two elements present in the compound have an Earth crust abundance of at least about 140 mg/kg.

Aspect 31. The compound of any one of aspects 1-27, wherein at least two elements present in the compound have an Earth crust abundance of from about 140 mg/kg to about 200 mg/kg.

Aspect 32. The compound of any one of aspects 1-31, wherein the compound is amorphous.

Aspect 33. The compound of any one of aspects 1-32, wherein the compound has peaks at about −1.1 ppm, −0.72 ppm, −0.60 ppm, and 2.87 ppm, as determined by 6Li solid-state NMR spectroscopy.

Aspect 34. A method for making a compound having the A_{z}N_{v-y}M_{y}OX_{5-y}, wherein A is Li, Na, K, or any combination thereof; N is Ta, Nb, or a combination thereof; M is Zr, Hf, or a combination thereof; X is Cl, Br, I, or any combination thereof; z is greater than zero to about 3; y is greater than zero to about 5; v is greater than or equal to y; and the sum (z+5v) is equal to 7. the method comprising (a) combining in the solid state the following components (i) A₂O, selected from the group consisting of Li₂O, Na₂O, K₂O, and any combination thereof; (ii) NX₅, selected from the group consisting of TaCl₅, TaBr₅, TaI₅, NbCl₅, NbBr₅, NbI₅, and any combination thereof; and (iii) MX₄ selected from the group consisting of ZrCl₄, ZrBr₄, ZrI₄, HfCl₄, HfBr₄, HfI₄ and any combination thereof, to produce a precursor mixture; and (b) mixing the precursor mixture by mechanochemical milling.

Aspect 35. The method of aspect 34, wherein precursor mixture is mixed by mechanochemical milling for about 1 hour to about 4 hours.

Aspect 36. The method of aspect 34, wherein precursor mixture is mixed by mechanochemical milling for about 2 hours.

Aspect 37. The method of any one of aspects 34-36, wherein the components are substantially anhydrous.

Aspect 38. The method of any one of aspects 34-37, wherein the components are mixed in an inert atmosphere.

Aspect 39. The method of any one of aspects 34-38, wherein the components are combined in stoichiometric amounts.

Aspect 40. A compound produced by the method of any one of aspects 34-39.

Aspect 41. An article comprising the compound in any one of aspects 1-33 and 40.

Aspect 42. The article of aspect 41, wherein the article is a battery or a component of a battery.

Aspect 43. The article of aspect 42, wherein the battery is a solid-state battery.

Aspect 44. The article of aspect 42 or 43, wherein the component of the battery is an electrolyte, a separator membrane, or a combination thereof.

Aspect 45. A sensor for ion detection, comprising the compound in any one of aspects 1-33 and 40.

Aspect 46. The sensor of aspect 45, wherein the ion comprises lithium ion.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

### Materials and Methods

### Synthesis

A stoichiometric amount of the starting chemicals, Lithium oxide (99.5% Alfa Aesar), anhydrous ZrCl₄ (99.9% Alfa Aesar), and TaCl₅ (99.99% Sigma Aldrich), were hand-ground for about 5 minutes in an argon-filled glovebox. The homogenous mixture was then transferred into a precleaned 20 mL zirconia milling jar, with three 10 mm-sized zirconia balls, and vacuum sealed within the argon-filled glovebox. Mechanochemical milling was conducted using the 8000M Mixer/Mill® High-Energy Ball Mill for 2 hours. The mechanically homogenized sample was transferred to the argon-filled glovebox (MBroun) and stored for further characterization.

### Characterization

Powder X-ray Diffraction—Characterization of the structure and phase composition was performed using a Rigaku SmartLab X-ray diffractometer in a Bragg-Brentano geometry with a Cu-Kα radiation source (0.154 nm). Data was acquired in the range of 20 values 10° to 70° at a step size of 0.03°. The powder samples were packed in a zero-background sample holder and sealed with Kapton film in an argon-filled glovebox.

Electrochemical Impedance Spectroscopy (EIS)—The sample was hand-ground and pressed in a 10 mm diameter mold to make a ˜0.8 mm thick pellet for impedance measurements. The pellet was assembled in a split cell with steel as the blocking electrode. The measurement of potentiostatic EIS was carried out using a Gamry electrochemical analyzer, and conductivities were calculated from the resulting Nyquist plots. Variable temperature EIS characterization was performed from −20° C. to 60° C. to calculate the activation energy via Arrhenius plots. Electronic conductivity was measured using the DC polarization method. Equilibrium currents were monitored at different voltages (100, 200, 300, and 400 mV).

Linear Sweep Voltammetry (LSV) measurements-150 mg of Li₂Ta_{0.9}Zr_{0.1}OCl_{4.9}, (LTZOC) was placed in a polyether ether ketone (PEEK) cylinder and pressed at 250 MPa for 1 min (10 mm diameter). To prepare the LTZOC-Carbon Nanofiber (Sigma-Aldrich) composite, LTZOC, and carbon nanofiber were mixed in a weight ratio of 9:1 and hand-ground in an agate mortar for 15 min. A mass of ˜8 mg of the composite was spread over one side of the SE pellet to serve as a working electrode and pressed at 350 MPa for another 1 min. On the other side of the pellet, a thin indium foil (10 mm diameter, 0.1 mm thickness) and ˜1.3 mg Li foil (Sigma-Aldrich) were hand-pressed. The cell was then placed into a stainless-steel casing with a constant applied pressure of 250 MPa. The LSV measurement was performed with a scan rate of 0.1 mV·s⁻¹ using a BioLogic-SP300.

### Results and Discussion

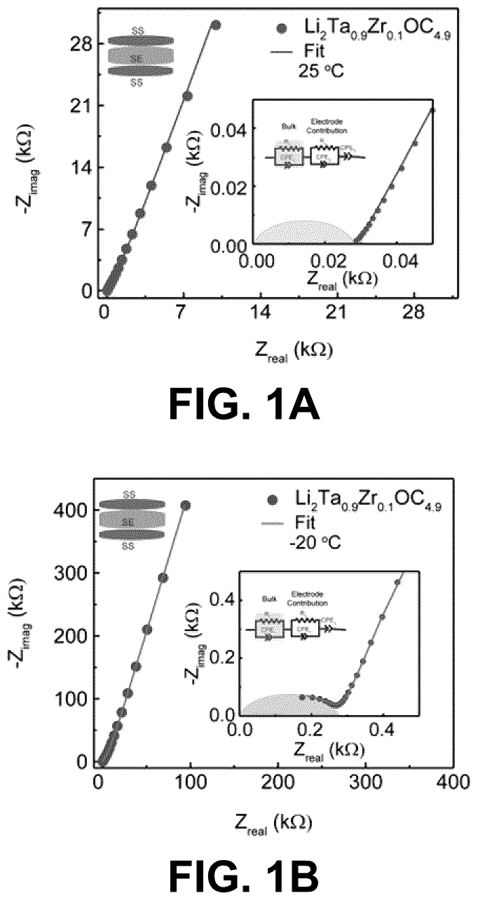

Electrochemical impedance spectroscopy (EIS) was used to measure the ionic conductivity of LTZOC using a symmetric Li ion blocking setup, Stainless steel (SS)|LTZOC|Stainless steel (SS). As shown in FIG. 1, Li₂Ta_{0.9}Zr_{0.1}OCl_{4.9} displays a room temperature superionic conductivity of ˜4.2 (7) mS/cm. The impedance spectra of LTZOC are composed of a single suppressed semicircle at high frequency and a sloped line at low frequency. The data was modeled with the two (RQ)+Q equivalent circuit models to quantitatively understand these processes and their contributions to the impedance in LTZOC. A resistor (R) connected in parallel to a constant phase element (Q) is represented by the symbol (RQ). A constant phase element was employed instead of a capacitor to account for heterogeneous surfaces between the steel electrode contacts and the pellet. The low-frequency tail is in line with capacitive build-up at steel-blocking electrodes. The high-frequency (RQ) semicircle can be attributed to a combination of bulk and grain-boundary impedances, as in other Li-ion conducting halide SEs. The incomplete (RQ) semicircle, which implies several overlapping processes at high frequencies, provides evidence for this. To differentiate between the contributions of the bulk (R_{b}) and grain-boundary (R_{gb}) to the total resistivity (Rₜ), a low temperature of −20° C. was selected rather than RT. The capacitance values extracted from the equivalent circuit fitting for LTZOC is 3.55×10⁻¹¹ F. It can be concluded that bulk and grain boundary contributions cannot be reasonably deconvoluted even at very low temperatures, such as −20° C. Therefore, the conductivities described here indicate total conductivities. A capacitance value of 3.77×10⁻⁷ F was extracted for the mid-frequency semicircle, which implies it's due to the electrode contribution.^{8,9}

Temperature-dependent impedance spectroscopy experiments were conducted to investigate the solid electrolytes' transport properties. FIG. 1C depicts representative Nyquist plots of the substitution series LTZOC in the −20° C. to 60° C. temperature range. The activation energy (Ea) of halide electrolytes was determined using the Arrhenius equation. LTZOC displayed a relatively low activation energy of 0.33 eV. It should be noted that the entire Arrhenius plot shows an almost linear variation, indicating that phase transitions or degradations do not occur in this temperature range.¹⁰

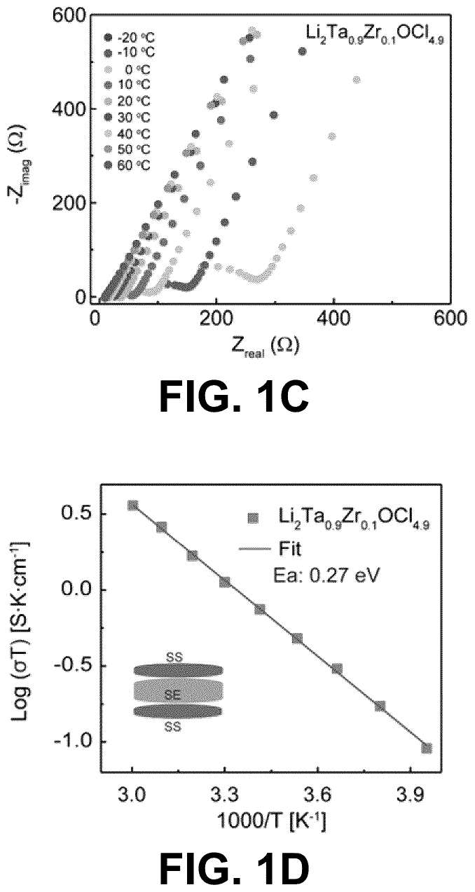

Investigation of electronic contribution (σₑₗ) to the total conductivity was carried out using the DC polarization technique in a symmetric setup SS|LTZOC|SS, shown in FIGS. 2A and 2B. The steady-state current cannot be reached if the polarization time is too short. Additionally, the stated values for electronic conductivity have a strong dependence on technique, making it challenging to compare other materials in the same class. Therefore, equilibrium currents were monitored at different voltages to increase the accuracy of DC polarization measurements. Then, using Ohm's rule (V=IR), the respective partial conductivities can be determined from the voltage vs. current plot.¹¹ The electronic conductivity of LTZOC is 4.59×10⁻¹⁰ Scm⁻¹, which is negligible compared to the corresponding ionic conductivity.

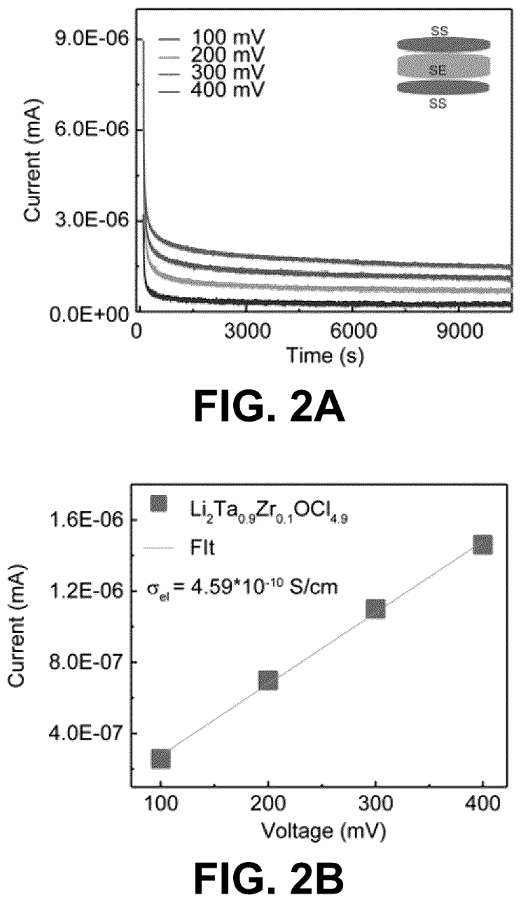

Because of the above-mentioned high ionic conductivity over a wide range of temperatures, LTZOC is anticipated to provide efficient cycle capabilities in all-solid-state batteries. Linear sweep voltammetry (LSV) studies were used to evaluate the electrochemical stability window of LTZOC to determine a suitable configuration for the LTZOC-based cells. In the cell assembled for the LSV experiment, a mixture of LTZOC and C (carbon black) with a weight ratio of 9:1 serves as the working electrode, LTZOC as the SE and Li/In alloy serves as the counter/reference.¹² The LSV curve in FIG. 3 shows a cathodic current onset potential of ˜3.4 V vs Li/Li+. Due to the relatively low Zr concentration in LTZOC compared to Ta, the Ta⁺ cation chemistry is the main origin of the electrochemical reduction process, which produces LiCl and Ta—Cl compounds with varying Ta/Cl ratios before reduction to Ta metal.

The anodic current onset potential is 2.1 V. For halide SEs, poor reduction stability is typical. The electrochemical oxidation process for LTZOC SE originates with the CI-anion chemistry, which yields compounds like Cl₂ and TaCl₅. As a result, LTZOC SE exhibits a broad electrochemical window, with a cathodic limit of 1.9 V (vs Li/Li⁺) and an anodic limit of 3.4 V (versus Li+/Li). Compared to many existing SSEs, the thermodynamic window is substantially broader, particularly for sulfide electrolytes like Li₆PS₅Cl (1.71-2.14) LGPS (1.72-2.42 V), that have ionic conductivities higher than 1 mS cm⁻¹.⁵

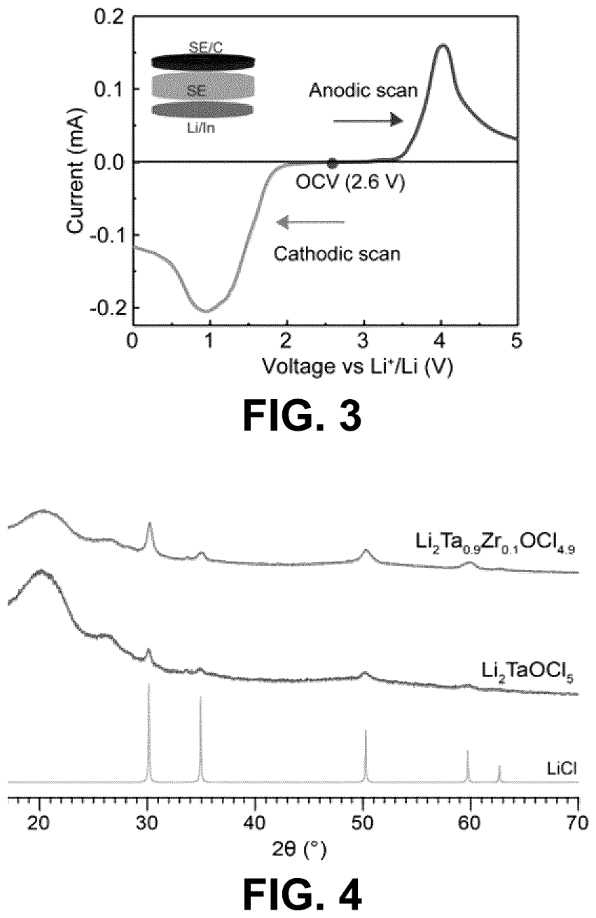

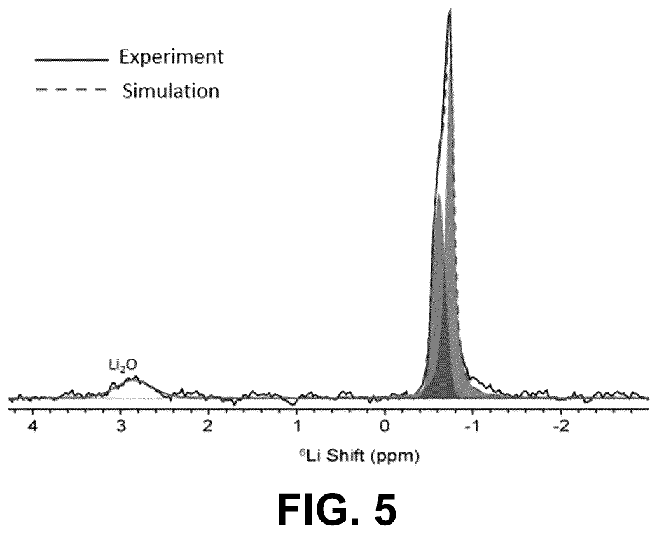

The diffraction pattern of FIG. 4 shows almost no crystalline patterns, except a couple of peaks attributed to minor secondary chloride phases. This shows the material possesses long-range disorder characteristic of glasses.

An additional compound described herein (Li₂TaZr_{0.2}OCl₄·8) was further evaluated.

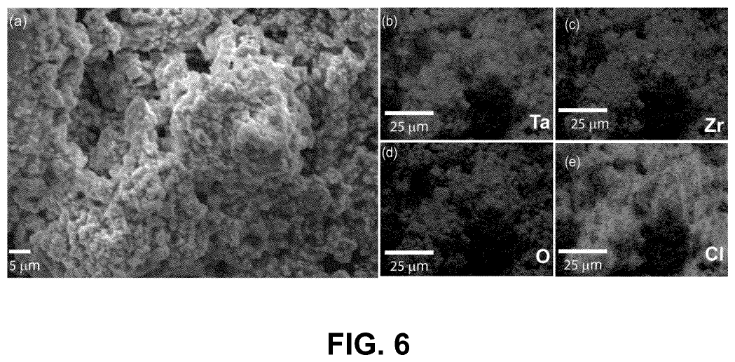

FIG. 6 shows the scanning electron microscope (SEM) and energy dispersive spectroscopy (EDS) mapping of as milled Li₂Ta_{0.8}Zr_{0.2}OCl_{4.8}. The SEM image reveals an agglomerated morphology with irregularly shaped particles ranging from sub-micron to several microns in size, likely resulting from mechanochemical milling. Elemental mapping using EDS shows a uniform distribution of Ta, Zr, O, and CI, indicating the successful formation of a homogeneous solid solution without noticeable phase segregation.

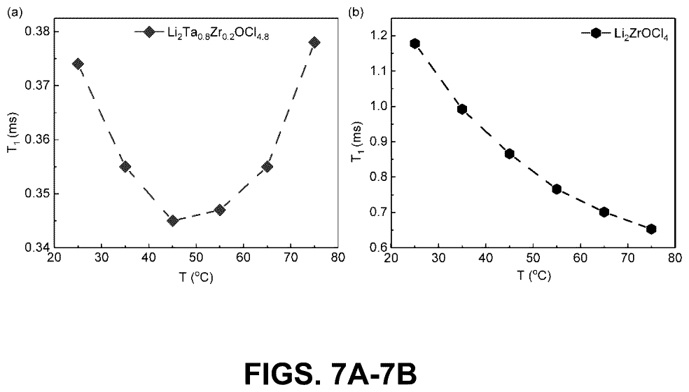

FIGS. 7A-7B show the variable temperature ⁷Li NMR T₁ relaxation measurement for (a) Li₂Ta_{0.8}Zr_{0.2}OCl_{4.8} and (b) Li₂ZrOCl₄. The ⁷Li NMR spin-lattice relaxation time (T₁) plots for Li₂Ta_{0.8}Zr_{0.2}OCl_{4.8} and Li₂ZrOCl₄ exhibit distinct temperature-dependent behaviors, which provide insights into lithium-ion dynamics in these amorphous materials. Li₂Ta_{0.8}Zr_{0.2}OCl_{4.8} exhibits a U-shaped Ti trend, with a minimum around 45° C., indicating an optimal lithium-ion hopping rate at this temperature. This suggests that lithium-ion motion reaches the NMR correlation time (˜116 MHz), signifying enhanced ion mobility. At both lower and higher temperatures, T₁ increases, reflecting transitions from slower to faster dynamics. This behavior aligns with the intermediate motional regime described by the Bloembergen-Purcell-Pound (BPP) theory. In contrast, Li₂ZrOCl₄ shows a monotonic decrease in T₁ with temperature, suggesting continuous acceleration of lithium motion without reaching an NMR frequency match, indicative of a different transport mechanism. The consistently longer T₁ values in Li₂ZrOCl₄ suggest a more constrained lithium environment and slower overall ionic motion.

The comparison indicates that Ta⁵⁺ substitution in Li₂Ta_{0.8}Zr_{0.2}OCl_{4.8} improves lithium-ion mobility, possibly by structural disorder or altering the local lithium coordination, reducing activation barriers for ion hopping. Even within an amorphous structure, these compositional differences influence ionic interactions and transport pathways. The absence of a Ti minimum in Li₂ZrOCl₄ suggests a less dynamically favorable lithium environment, while Li₂TaZr_{0.2}OCl_{4.8} benefits from increased cationic disorder, facilitating more efficient Li-ion transport.

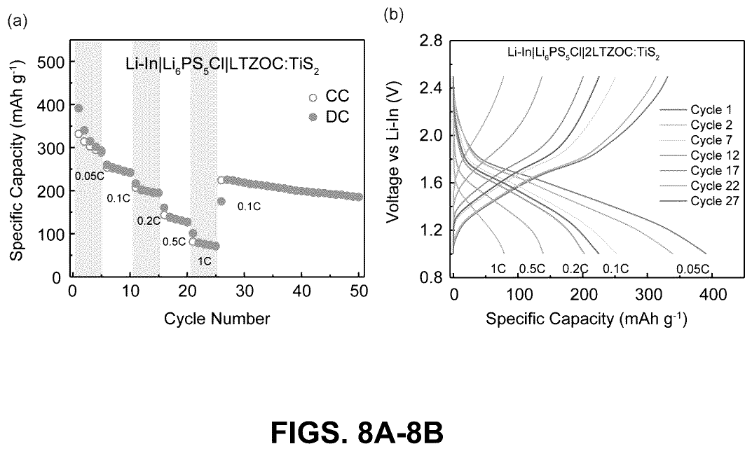

FIGS. 8A-8B show the all-solid-state battery cycling performance of Li₂Ta_{0.8}Zr_{0.2}OCl_{4.8} (a) rate capability plots and (b) voltage-capacity profiles showing the charge-discharge curves at 0.05, 0.1, 0.2, 0.5 and 1 C. Li₂Ta_{0.8}Zr_{0.2}OCl_{4.8} exhibits good cycling performance, with 90% capacity retention after 50 cycles at 0.1 C.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

(1) Janek, J.; Zeier, W. G. A Solid Future for Battery Development. Nature Energy. Nature Publishing Group Sep. 8, 2016. DOI: 10.1038/nenergy.2016.141.
(2) Sun, Y. K. Promising All-Solid-State Batteries for Future Electric Vehicles. ACS Energy Letters. American Chemical Society Oct. 9, 2020, pp 3221-3223. DOI: 10.1021/acsenergylett.0c01977.
(3) Janek, J.; Zeier, W. G. Challenges in Speeding up Solid-State Battery Development. Nature Energy. Nature Research 2023. DOI: 10.1038/s41560-023-01208-9.
(4) Wang, Y.; Richards, W. D.; Ong, S. P.; Miara, L. J.; Kim, J. C.; Mo, Y.; Ceder, G. Design Principles for Solid-State Lithium Superionic Conductors. Nat Mater 2015, 14 (10), 1026-1031. DOI: 10.1038/nmat4369.
(5) Tanaka, Y.; Ueno, K.; Mizuno, K.; Takeuchi, K.; Asano, T.; Sakai, A. New Oxyhalide Solid Electrolytes with High Lithium Ionic Conductivity &gt;10 MS/Cm for All-Solid-State Batteries. Angewandte Chemie International Edition 2023. DOI: 10.1002/anie.202217581.
(6) Hu, L.; Wang, J.; Wang, K.; Gu, Z.; Xi, Z.; Li, H.; Chen, F.; Wang, Y.; Li, Z.; Ma, C. A Cost-Effective, Ionically Conductive and Compressible Oxychloride Solid-State Electrolyte for Stable All-Solid-State Lithium-Based Batteries. Nat Commun 2023, 14 (1). DOI: 10.1038/s41467-023-39522-1.
(7) Zhang, S.; Zhao, F.; Chen, J.; Fu, J.; Luo, J.; Alahakoon, S. H.; Chang, L. Y.; Feng, R.; Shakouri, M.; Liang, J.; Zhao, Y.; Li, X.; He, L.; Huang, Y.; Sham, T. K.; Sun, X. A Family of Oxychloride Amorphous Solid Electrolytes for Long-Cycling All-Solid-State Lithium Batteries. Nat Commun 2023, 14 (1). DOI: 10.1038/s41467-023-39197-8.
(8) Kwak, H.; Han, D.; Lyoo, J.; Park, J.; Jung, S. H.; Han, Y.; Kwon, G.; Kim, H.; Hong, S. T.; Nam, K. W.; Jung, Y. S. New Cost-Effective Halide Solid Electrolytes for All-Solid-State Batteries: Mechanochemically Prepared Fe3+-Substituted Li2ZrCl6. Adv Energy Mater 2021, 11 (12). DOI: 10.1002/aenm.202003190.
(9) Umeshbabu, E.; Maddukuri, S.; Hu, Y.; Fichtner, M.; Munnangi, A. R. Influence of Chloride Ion Substitution on Lithium-Ion Conductivity and Electrochemical Stability in a Dual-Halogen Solid-State Electrolyte. ACS Appl Mater Interfaces 2022, 14 (22), 25448-25456. DOI: 10.1021/acsami.2c04160.
(10) Park, K. H.; Kim, S. Y.; Jung, M.; Lee, S. Bin; Kim, M. J.; Yang, I. J.; Hwang, J. H.; Cho, W.; Chen, G.; Kim, K. S.; Yu, J. Anion Engineering for Stabilizing Li Interstitial Sites in Halide Solid Electrolytes for All-Solid-State Li Batteries. ACS Appl Mater Interfaces 2023. DOI: 10.1021/acsami.3c13002.
(11) Li, B.; Li, Y.; Zhang, H. S.; Wu, T. T.; Guo, S.; Cao, A. M. Fast Li+-Conducting Zr4+-Based Oxychloride Electrolyte with Good Thermal and Solvent Stability. Sci China Mater 2023, 66 (8), 3123-3128. DOI: 10.1007/s40843-023-2434-4.
(12) Wang, J.; Chen, F.; Hu, L.; Ma, C. Alternate Crystal Structure Achieving Ionic Conductivity above 1 MS Cm-1 in Cost-Effective Zr-Based Chloride Solid Electrolytes. Nano Lett 2023, 23 (13), 6081-6087. DOI: 10.1021/acs.nanolett.3c01468.

1. A compound having the formula A_{z}N_{v-y}M_{y}OX_{5-y}, wherein
A is Li, Na, K, or any combination thereof;
N is Ta, Nb, or a combination thereof;
M is Zr, Hf, or a combination thereof;
X is Cl, Br, I, or any combination thereof;
z is greater than zero to 3;
y is greater than zero to 5;
v is greater than or equal to y; and
the sum (z+5v) is equal to 7.

2. The compound of claim 1, wherein A is Li or Na.

3. The compound of claim 1, wherein z is from 0.01 to 3.0.

4. The compound of claim 1, wherein N is Ta.

5. The compound of claim 1, wherein M is Zr.

6. The compound of claim 1, wherein X is CI or Br.

7. The compound of claim 1, wherein y is from 0.01 to 5.00.

8. The compound of claim 1, wherein v is from 0.01 to 5.00.

9. The compound of claim 1, wherein the compound is Li₂Ta_{1-y}Zr_{y}OCl_{5-y}.

10. The compound of claim 9, wherein y is from 0.01 to 0.50.

11. The compound of claim 1, wherein the compound is Li₂Ta_{0.9}Zr_{0.1}OCl_{4.9} or Li₂Ta_{0.8}Zr_{0.2}OCl_{4.8}.

12. The compound of claim 1, wherein the compound has an ionic conductivity of 1.0 mS/cm to 6.0 mS/cm and an electronic conductivity of 1.00×10⁻⁸ S/cm to 1.00×10⁻¹¹ S/cm.

13. The compound of claim 1, wherein the compound is conductive over a temperature range of −20° C. to 80° C., the compound exhibits superionic conductivity over a temperature range of −20° C. to 80° C., and the compound has an activation energy for ion transport of from 0.1 eV to 0.6 eV.

14. A method for making a compound having the A_{z}N_{v-y}M_{y}OX_{5-y}, wherein
A is Li, Na, K, or any combination thereof;
N is Ta, Nb, or a combination thereof;
M is Zr, Hf, or a combination thereof;
X is Cl, Br, I, or any combination thereof;
z is greater than zero to 3;
y is greater than zero to 5;
v is greater than or equal to y; and
the sum (z+5v) is equal to 7.
the method comprising:
(a) combining in the solid state the following components: (i) A₂O, selected from the group consisting of Li₂O, Na₂O, K₂O, and any combination thereof; (ii) NX₅, selected from the group consisting of TaCl₅, TaBr₅, TaI₅, NbCl₅, NbBr₅, NbI₅, and any combination thereof; and (iii) MX₄ selected from the group consisting of ZrCl₄, ZrBr₄, ZrI₄, HfCl₄, HfBr₄, HfI₄ and any combination thereof, to produce a precursor mixture; and
(b) mixing the precursor mixture by mechanochemical milling.

15. A compound produced by the method of claim 14.

16. An article comprising the compound of claim 1.

17. The article of claim 16, wherein the article is a battery or component of a battery.

18. The article of claim 16, wherein the article is a solid-state battery.

19. The article of claim 17, wherein the component of the battery is an electrolyte, a separator membrane, or a combination thereof.

20. A sensor for ion detection, comprising the compound of claim 1.
